(19) United States
(12) Patent Application Publication
(10) Pub. No.: US 2024/0230854 A1
(43) Pub. Date: Jul. 11, 2024

(54) DEVICE AND METHOD FOR SCANNING MEASUREMENT OF THE DISTANCE TO AN OBJECT

(71) Applicant: Scantinel Photonics GmbH, Ulm (DE)

(72) Inventor: Jan HORN, München (DE)

(21) Appl. No.: 18/612,997

(22) Filed: Mar. 21, 2024

Related U.S. Application Data
(63) Continuation of application No. PCT/EP2022/081256, filed on Nov. 9, 2022.

(30) Foreign Application Priority Data
Nov. 23, 2021 (DE) 102021130609.4

(51) Int. Cl. G01S 7/481; G01S 7/4912; G01S 7/497; G01S 17/34; G01S 17/931

(52) U.S. Cl. CPC G01S 7/4817; G01S 7/4917; G01S 7/497; G01S 17/34; G01S 17/931

(57) ABSTRACT

A device for scanning measurement of the distance to an object has a light source which generates an optical signal having a varying frequency. A scanning device directs measuring light in different directions. A detector detects a superposition of reference light and reflected light. An evaluation device determines a distance to the object from the superposition detected by the detector. A light sensor, which is arranged in the light path of the emitted measuring light behind the scanning device in such a way that it is exposed to the measuring light only once per scanning cycle, detects a scanning movement of the emitted measuring light. A switch-off device switches off the light source or otherwise prevents the emission of measuring light if the light sensor does not detect a scanning movement of the measuring light.

### CROSS-REFERENCE TO RELATED APPLICATIONS

This application is a continuation application of International Patent Application No. PCT/EP2022/081256, filed Nov. 9, 2022, which claims the benefit of, and priority to, German patent application No. 10 2021 130 609.4, filed Nov. 23, 2021. Each of these applications is incorporated by reference herein in its entirety.

### BACKGROUND OF THE INVENTION

### 1. Field of the Invention

The invention relates to a device and a method for scanning measurement of the distance to a moving or stationary object based on FMCW LiDAR technology. Devices and methods of this kind can be used, for example, in autonomously driving vehicles.

### 2. Description of the State of the Art

For optical distance measurement, a measurement principle known as FMCW LiDAR is known, in which optical signals with a time-varying frequency (FMCW stands for frequency modulated continuous wave) are directed from a scanning device in different directions onto an object to be measured. After reflection at the object, these signals return to the scanning device with low intensity and are superimposed with a signal that was not emitted and is therefore referred to as a local oscillator. The resulting beat frequency is recorded by a detector and allows the distance between the scanner and the object to be calculated. If the Doppler shift is also taken into account, the radial relative speed between the scanner and the object can also be calculated.

FMCW LiDAR devices usually contain a laser light source that generates measuring light with a wavelength of 1550 nm. As this frequency is in the infrared spectral range and therefore outside the visible spectrum, the measuring light cannot be perceived by humans. In addition, infrared light is only harmful to the eyes at very high power levels. This means that FMCW LiDAR devices with high-intensity measuring light can measure distances of up to 300 m without posing a risk to eye safety.

Even greater ranges require correspondingly higher laser power. A high intensity of the measuring light is also desirable with regard to a high signal-to-noise ratio and thus the reliability of the distance determination.

However, infrared measuring light with very high intensities is only harmless to the eyes if it briefly hits the retina of the eye, as is normally the case during scanning. However, if the scanning device is defective, the measuring beam may stop moving. If such a stationary and high-intensity measuring beam reaches a human eye, damages cannot be ruled out.

### SUMMARY OF THE INVENTION

An object of the invention is to provide a device and a method for scanning FMCW LiDAR measurement of the distance to an object, in which measurement light can be emitted with high intensity without causing damage to the eyes of persons in the vicinity and without significantly disturbing the propagation of the measurement light.

With regard to the device, this object is achieved by a device for scanning measurement of the distance to an object, which comprises a light source configured to generate an optical signal having a varying frequency. The device also comprises a scanning device configured to direct measuring light in different directions. The measuring light is formed by a first part of the optical signal generated by the light source. The device also has a detector configured to detect a superposition of reference light and reflected light. The reference light is formed by a second part of the optical signal generated by the light source, which is not supplied to the scanning device. The reflected light is formed by the measurement light after it has been at least partially reflected by the object. An evaluation device of the device is configured to determine a distance to the object based on the superposition detected by the detector. According to the invention, the device has a monitoring device comprising a light sensor, which can be a photodiode, for example. The light sensor is arranged in the light path of the emitted measuring light behind the scanning device and is configured to detect a scanning movement of the emitted measuring light. The light sensor is arranged in such a way that it is only exposed to the measuring light once per scan cycle. The monitoring device also has a switch-off device that is connected to the light sensor and the light source and is configured to switch off the light source or otherwise prevent the emission of measuring light if the light sensor does not detect a scanning movement of the measuring light.

The invention is based on the consideration that (in particular infrared) measuring light may be emitted with a high intensity as long as the measuring beam or beams are moving, thereby ensuring that measuring light cannot reach people's eyes over a longer period of time. Whether the scanning device, which generates the movements of the measuring light, functions correctly and the measuring light performs the desired scanning movements can only be reliably detected by a light sensor in the light path behind the scanning device. Especially if the scanning device does not contain any moving parts, it is difficult to detect scanning movements of the measuring light within the scanning device. Scanning devices without moving parts are preferably realized as photonic integrated circuits, which are difficult to interfere with.

With a simple light sensor in the light path behind the scanning device, on the other hand, it is very easy to determine whether the measuring light is still performing the desired scanning movements or not.

According to the invention, the light sensor is arranged in such a way that it is only exposed to the measuring light once per scan cycle. The idea behind this is that the measuring light does not have to be monitored continuously, but that it is sufficient to detect the measuring light with the light sensor only once per scan cycle. As scanning movements are usually periodic, a light sensor positioned at a reversal point of the measuring light beam makes it easy to determine whether the scanning process is still being carried out without errors. If the scanning process is error-free, the light sensor detects a signal at the reversal point at periodic intervals. If this does not occur, it can be assumed that the scanning device is no longer functioning correctly and that the measuring light beam must therefore be prevented from propagating any further. In this configuration, the light sensor is therefore located in the area of a reversal point and therefore at the edge of the scanning field. There, the light sensor does not significantly interfere with the propagation of the measuring light.

If scanning is to take place in two orthogonal directions, at least one light sensor should be provided for each scanning direction in order to be able to monitor both scanning movements independently of each other. If the measuring light passes over a field surrounded by a contour during the scanning process, two or more light sensors can be arranged around this field. For example, several light sensors can be arranged at the edge of a light emission window of the device.

Various measures can be taken to prevent measuring light from continuing to be emitted in a single direction in the event of a faulty scanning device. For example, it is possible to actively close an aperture through which the measuring light must pass during normal operation. Such a closable aperture can, for example, contain a shutter plate that is unlocked by an actuator when required and automatically closes the aperture opening under the effect of gravity.

However, it is simpler and safer to switch off the light source so that measuring light is not generated in the first place. For this purpose, the switch-off device can, for example, have a switching relay or a safe semiconductor switch that is configured to interrupt the power supply to the light source in response to a control signal.

The invention can be used advantageously regardless of how the scanning device is constructed. A scanning device with an optical distribution matrix, which has several optical switches and/or optical splitters and is configured to distribute the measuring light simultaneously or successively to several optical output waveguides, is particularly robust and can be manufactured in large quantities at low cost. A deflection optics of the scanning device is configured to deflect the measuring light emerging from the optical output waveguides in such a way that it is emitted in different directions. A scanning device constructed in this way and known per se can be used for one or both scanning directions. If scanning is to be performed in two scanning directions, the output waveguides must be arranged in two dimensions.

Alternatively or additionally, the scanning device can have a dispersive optical element that directs the measuring light in different directions depending on the wavelength.

Alternatively or additionally, the scanning device can have a rotatably mounted optical element that has a reflective surface. Such a rotatably mounted optical element can be set into rotary oscillation by a galvanometer drive, be designed as a continuously rotating scanning prism or be a micromirror of a micromirror array constructed using MEMS technology, as is known in the prior art.

With regard to the method, the object mentioned at the beginning is solved by a method for scanning measurement of the distance to an object, which comprises the following steps:
a) generating an optical signal having a varying frequency;
b) directing measuring light in different directions, the measuring being light being formed by a first part of the optical signal;
c) detecting a superposition of reference light and reflected light, wherein
   the reference light is formed by a second part of the optical signal which is not directed in different directions, and wherein
   the reflected light is formed by the measuring light after it has been at least partially reflected by the object;
d) determining a distance to the object based on the superposition detected in step c);
e) detecting a scanning movement of the emitted measuring light with a light sensor, which is arranged in such a way that it is exposed to the measuring light only once per scan cycle;
f) preventing the measuring light from being emitted as soon as the light sensor in step e) no longer detects any scanning movement of the measuring light.

The comments and advantageous embodiments mentioned above for the device apply accordingly to the method.

### BRIEF DESCRIPTION OF THE DRAWINGS

Further features and advantages of the invention will become apparent from the following description of exemplary embodiments with reference to the drawings, in which:

FIG. 1 is a schematic side view of a vehicle approaching an object detected by a measuring device according to the invention;

FIG. 2 is a top view of the measuring device shown in FIG. 1;

FIG. 3 shows the structure of the measuring device according to an embodiment in a schematic representation;

FIG. 4 is a graph in which the frequency of the emitted optical signals is plotted as a function of time;

FIG. 5 shows parts of the measuring device shown in FIG. 3 with additional details in a schematic representation; and

FIG. 6 is a graph in which the photocurrent of two photodiodes used as light sensors is plotted as a function of time.

### DESCRIPTION OF PREFERRED EMBODIMENTS

### 1. Example of Use

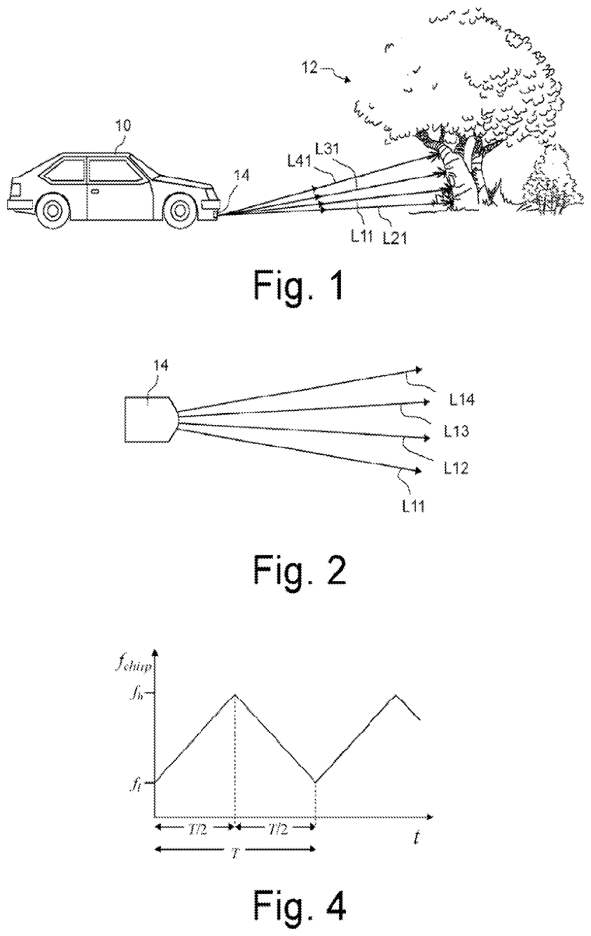

FIG. 1 shows a schematic side view of a vehicle 10 approaching an object 12, which in FIG. 1 is a tree. The vehicle 10 has at least one measuring device 14, which uses light beams L11, L21, L31 and L41 to scan the environment ahead of the vehicle 10, from which a three-dimensional image of the environment is calculated. In addition, the measuring device 14 determines the relative speed to the object 12. This information is particularly important if the object 12 is another vehicle or an animal that is also moving.

The information determined by the measuring device 14 about the environment ahead of the vehicle 10 can be used, for example, to assist the driver of the vehicle 10 in controlling the vehicle by generating warning messages when a collision of the vehicle 10 with the object 12 is imminent. If the vehicle 10 is driving autonomously, the information about the environment ahead is required by the control algorithms that control the vehicle 10.

As can be seen in FIG. 1, the scanning device 14 emits the light beams L11 to L41 in a vertical plane (in FIG. 1 this is the paper plane) in different directions, whereby the environment is scanned in a vertical direction. At the same time, scanning also takes place in a horizontal direction, as shown in FIG. 2 in a top view of the measuring device 14. Four light beams L11, L12, L13 and L14 are shown there, which are emitted in different directions in a horizontal plane.

For reasons of clarity, it is assumed in FIGS. 1 and 2 that only four light beams Ln1 to Ln4 are generated by the scanning device 14 in four different planes, i.e. a total of 16 light beams. Preferably, the measuring device 14 emits many more light beams. For example, k·2ⁿ light beams are preferred, where n is a natural number between 7 and 13 and indicates how many beams are emitted in one of k planes, where k is a natural number between 1 and 16. Depending on the technology used, the different light beams Ln1 to Ln4 can be emitted successively or at least partially simultaneously.

### 2. Measuring Device

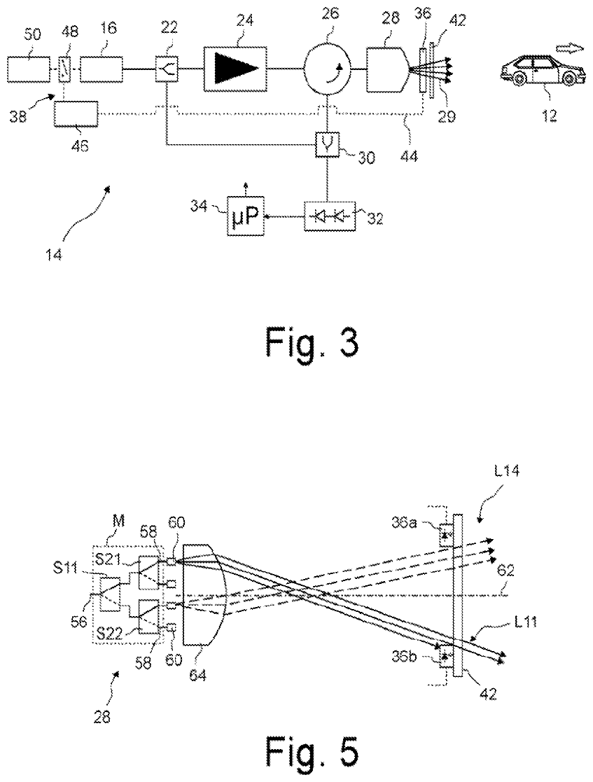

FIG. 3 schematically shows the structure of the measuring device 14 according to an embodiment of the invention. The measuring device 14 is designed as a LiDAR system and comprises an FMCW light source 16, which generates measuring light having a varying frequency f_{chirp} during operation of the measuring device 14. As illustrated in FIG. 4, the frequency f_{chirp} varies (“chirps”) periodically over time t between a lower frequency fₗ and a higher frequency fₕ. The center frequency of the measured light is 1550 nm and thus in the infrared spectral range.

Each measurement interval with a chirp duration T is divided into two halves of equal length T/2. During the first interval, the frequency f_{chirp} increases linearly with a constant and positive upchirp rate r_{chirp}, i.e. df_{chirp}/dt=r_{chirp}. During the second interval, the frequency f_{chirp} decreases linearly with a constant negative downchirp rate −r_{chirp}, i.e. df_{chirp}/dt_{chirp}=−r_{chirp}, decreases. The frequency of the measured light can therefore be described by a periodic triangular function. However, other functional relationships can also be considered, e.g. sawtooth functions.

As can be seen in FIG. 3, the light source 16 is connected to a splitter 22, which splits the optical signals generated by the light source 16 into two parts. A smaller part of the optical signals is separated and is referred to as reference light or local oscillator. The remaining part of the optical signals, referred to below as measuring light, is first amplified in an optical amplifier 24 and then passes to an optical circulator 26, which feeds the amplified measuring light to a scanning device 28. An optical circulator has at least three connections and the property that light entering one connection leaves the next connection. Instead of the circulator, a 2×2 coupler can also be used, for example, but this leads to higher light losses.

The scanning device 28 directs the measuring light 29 onto the object 12—represented by a moving car in FIG. 3—along different directions, as explained above with reference to FIGS. 1 and 2. Several measuring beams can also be emitted simultaneously in different directions. Usually, the measuring light emitted by the scanning device 28 is at least partially diffusely reflected by the object 12. A small part of the reflected light returns to the measuring device 14, where it can be coupled back into the scanning device 28.

The optical circulator 26 directs the coupled-in reflected light to a combiner 30, which superimposes the reference light, which was previously separated from the optical signals by the splitter 22, with the coupled-in reflected light. Since the frequencies of the superimposed light components differ slightly from one another, a beat signal is produced, which is detected by a detector 32, which is preferably designed as a balanced photodetector. The electrical signals generated by the detector 32 are fed to a computing unit 34, which calculates the distance R to the object and the relative velocity v between the scanning device 14 and the object 12 based on the analysis of the beat frequencies.

Preferably, some or all of the components described above are realized as a photonic integrated circuit (PIC). This allows a very compact design, high mechanical robustness and low unit costs in mass production.

The measuring device 14 also comprises a monitoring device, which includes a light sensor 36, indicated schematically by 36, and a switch-off device 38. The light sensor 36 is arranged in the light path of the measuring light behind the scanning device 28 and in front of an exit window 42 of the measuring device 14 and has the task of detecting the scanning movements of the emitted measuring light 29.

The light sensor 36 is connected via a dotted data line 44 to the switch-off device 38, which comprises an electronic control device 46 and a switching relay 48. The switching relay 48 is connected between the light source 16 and a power source 50, which supplies the light source with power.

If the light sensor 36 no longer detects any scanning movements of the measuring light 29, the control device 46 generates a control signal for the switching relay 48, which then immediately interrupts the power supply to the light source 16. This ensures that the measuring light 29 is not emitted in one direction (or in several fixed directions in the case of a multi-channel measuring device 14) over a longer period of time, which could cause eye damage to persons in the vicinity of the measuring device 14.

FIG. 5 shows the scanning device 28 in a simplified schematic representation. In this embodiment, the scanning device 28 comprises a distribution matrix M in which a plurality of optical switches S11, S21 and S22 are arranged in a tree-like manner. With the aid of the optical distribution matrix M, measurement light can be successively distributed from an input 56 of the distribution matrix M to several output waveguides 58. For reasons of clarity, the optical distribution matrix M in the embodiment shown has only three optical switches S11, S21 and S22, so that a total of four output waveguides 58 can be controlled. In real measuring devices 14, eight or more switching levels can be arranged in series so that, for example, 256 output waveguides 58 can be optionally connected to the input 56.

In other embodiments, the distribution matrix M is located upstream of the amplifier 24 or between the amplifier 24 and the circulator 26. This is particularly useful if several optical signals are to be emitted simultaneously by supplying optical signals to several distribution matrices in parallel. Alternative embodiments for the integration of distribution matrices into the measuring device 14 can be found in EP 3 916 424 A1 and DE 10 2020 110 142 A1.

The output waveguides 58 terminate in free-space couplers 60, which out-couple the measured light guided in the output waveguides 58 into the free space. Such couplers are known in the prior art and can, for example, be designed as grating couplers, which have a widening waveguide area adjoined by a grating structure. Alternatively, the free-space couplers 60 can be edge couplers, which have a higher coupling efficiency than grating couplers.

FIG. 5 shows that the measuring light beams emerging divergently from the free-space couplers 60 are collimated by a deflection optic 64 and emitted in different directions. The further a free-space coupler 60 is spaced from an optical axis 62 of the deflection optics, the greater the angle at which the collimated measuring light is emitted by the deflection optics 64.

In the embodiment shown, it is assumed that scanning takes place in an (at least approximately) horizontal plane that coincides with the paper plane of FIG. 5. In order to also be able to scan in the vertical plane perpendicular to this, i.e. perpendicular to the paper plane of FIG. 5, a rotating reflective optical element (not shown) can be provided, for example, as is known in the prior art.

In the embodiment shown, the scanning device 28 also serves to receive the optical signals reflected from the object 12 and to couple them back into the output waveguides 68 via the free-space couplers 60. In other embodiments, the reflected signals may be received by dedicated free-space couplers 60 and fed to the detector 32 via dedicated waveguides.

In this embodiment, the monitoring device has a total of four light sensors, two of which are recognizable in FIG. 5 and are designated 36a, 36b. The light sensors 36a, 36b can, for example, be designed as photodiodes that are sensitive to the infrared measuring light 29. The four light sensors 36a, 36b are arranged at the edges of a rectangular scanning field, which is swept by the measuring light 29 during a scanning process. For this purpose, the light sensors 36a, 36b can, for example, be attached to the edge of the likewise rectangular exit window 42 of the measuring device 14.

The opposing light sensors 36a, 36b detect the correct scanning process in the horizontal plane. During the switching through of the distribution matrix M, the measuring light beams periodically swivel back and forth, as indicated in FIG. 5. A slower scanning movement in the vertical direction is superimposed on this fast scanning movement.

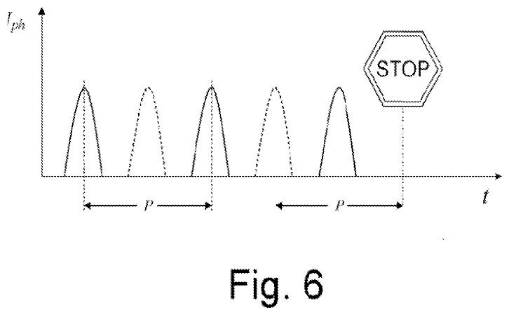

The light sensors 36a, 36b are positioned in such a way that at the reversal points of the horizontal scanning movement they are each briefly exposed to a portion of the measuring light 29 and then each generate a brief electrical measuring signal which is monitored by the control device 46. During a proper scanning process, the measurement signals generated by the light sensors 36a, 36b return regularly with a period P, as illustrated by the graph in FIG. 6. There, the photocurrent Iₚₕ generated by the light sensors 36a and 36b is plotted as a solid or dashed line over the time t. If the control device 46 detects that after a period P one of the light sensors 36a, 36b no longer receives a measurement signal, the control device 46 assumes that the scanning process is disturbed and the measurement light is only emitted in one direction. The control device 46 then generates the control signal for the switching relay 48 as described above in order to immediately interrupt the power supply to the light source 16.

1. A device for scanning measurement of the distance to an object, comprising
a light source configured to generate an optical signal having a varying frequency,
a scanning device configured to direct measuring light in different directions, the measuring light being formed by a first part of the optical signal generated by the light source,
a detector configured to detect a superposition of reference light and reflected light, wherein
the reference light is formed by a second part of the optical signal generated by the light source which is not supplied to the scanning device, and wherein
the reflected light is formed by the measuring light after it has been at least partially reflected by the object,
an evaluation device which is configured to determine a distance to the object based on the superposition detected by the detector,
a monitoring device comprising
a light sensor which is arranged in the light path of the emitted measuring light behind the scanning device and is configured to detect a scanning movement of the emitted measuring light, the light sensor being arranged such that it is exposed to the measuring light only once per scanning cycle, and
a switch-off device which is connected to the light sensor and is configured to switch off the light source or otherwise prevent emission of measuring light if the light sensor does not detect a scanning movement of the measuring light.

2. The device of claim 1, wherein a plurality of light sensors are arranged around a field which is swept by the measuring light during a scanning cycle.

3. The device of claim 1, wherein the cut-off device comprises a switching relay or a safe semiconductor switch configured to interrupt the power supply to the light source in response to a control signal.

4. The device according of claim 1, wherein the scanning device comprises
an optical distribution matrix comprising a plurality of optical switches and/or optical splitters and configured to distribute the measurement light simultaneously or successively to a plurality of optical output waveguides, and
deflection optics which are configured to deflect the measuring light emerging from the optical output waveguides in such a way that it is emitted in different directions.

5. The device of claim 1, wherein the scanning device comprises a rotatably mounted optical element comprising a reflective surface.

6. A method for scanning measurement of the distance to an object, wherein the method comprises the following steps:
a) generating an optical signal having a varying frequency;
b) directing measuring light in different directions, the measuring light being formed by a first part of the optical signal;
c) detecting a superposition of reference light and reflected light, wherein
the reference light is formed by a second part of the optical signal which is not directed in different directions, and wherein
the reflected light is formed by the measuring light after it has been at least partially reflected by the object;
d) determining a distance to the object based on the superposition detected in step c);
e) detecting a scanning movement of the emitted measuring light with a light sensor, which is arranged in such a way that it is exposed to the measuring light only once per scanning cycle; and
f) preventing measuring light from being emitted as soon as the light sensor in step e) no longer detects any scanning movement of the measuring light.
